(19) United States
(12) Patent Application Publication
(10) Pub. No.: US 2025/0253918 A1
(43) Pub. Date: Aug. 7, 2025

(54) BEAMFORMING MANAGEMENT ENHANCEMENTS FOR NR MULTICAST SERVICE

(71) Applicant: APPLE INC., CUPERTINO, CA (US)

(72) Inventors: Pengkai ZHAO, CUPERTINO, CA (US); Haitong SUN, CUPERTINO, CA (US); Yushu ZHANG, BEIJING (CN); Chunhai YAO, BEIJING (CN)

(21) Appl. No.: 18/857,638

(22) PCT Filed: Apr. 29, 2022
(86) PCT No.: PCT/CN2022/090442

§ 371 Date: Oct. 17, 2024

(51) Int. Cl. H04B 7/06; H04W 72/30

(52) U.S. Cl. CPC H04B 7/06952; H04W 72/30

(57) ABSTRACT

Methods and systems are disclosed for enhancements to multicast beamforming to support PTM multicast service, concurrent multicast and unicast service, MBS, or group side-link service at the physical layer. A base station or multicast UEs of a wireless communication network may enhance the management and adaptation of downlink multicast beams used to provide the service. Enhancements to multicast beamforming may include techniques such as joint consideration of multicast and unicast performance of UEs receiving concurrent multicast and unicast physical downlink traffic when selecting multicast beamforming, multicast beamforming to reduce interference of the multicast transmission on unicast UEs receiving unicast service, support for PTM or PTP multicast transmission at the physical layer to accommodate UE preferences for PTM/PTP in multicast beam failure detection and recovery process. The enhancements improve multicast service performance, flexibly accommodate the provisioning of simultaneous multicast and unicast services, and enhance multicast beam failure detection and recovery process.

### FIELD OF INVENTION

This invention relates generally to the field of wireless communication, and more particularly, to systems and methods for operating a communication network with beamforming capability when a base station of the communication network transmits to multiples wireless communication devices simultaneously in a multicast configuration. Other aspects are also described.

### BACKGROUND OF THE INVENTION

In a wireless communications network, a user equipment (UE) may communicate with a base station of the network by establishing a radio link between the UE and the base station. In the 5G (New Radio or NR) or 4G (LTE) wireless network, a UE may receive signaling and data from the serving base station in a downlink transmission direction or transmit signaling and data to the serving base station in an uplink transmission direction. The base station, UE, or both may use beamforming to improve the link budget in the downlink and uplink directions by increasing the antenna gain of the transmitting and/or receiving antenna beams. This may be particularly beneficial for higher operating bands that experience greater air-interface interference. Beamforming may also help to reduce inter-cell interference by focusing transmissions in a relatively narrow beam.

In one operating scenario, the base station may use beamforming to provide signaling and data simultaneously in time to multiple UEs by transmitting a common beam to the multiple UEs. In this operating scenario, the base station provides point-to-multipoint (PTM) multicast service at the physical layer and may be referred to as multicast beamforming. In an alternative operating scenario, the base station may generate multicast data at the application layer but may transmit different beams to the multiple UEs using a point-to-point (PTP) configuration at the physical layer to provide the multicast service. Beamforming design to support multicast beamforming may rely on the base station determining the quality of the downlink channel to each of the UEs based on the received uplink transmissions from the UEs and based on the assumption of reciprocity of the channel characteristics between the uplink and downlink directions. Alternatively, to obtain a more accurate characterization of the downlink channels to the UEs, the base station may transmit reference signals or synchronization signals on candidate beams for the UEs to estimate the quality of the downlink channels as in unicast beamforming. The UEs may measure and report back to the base station the downlink channel quality estimated from the received reference or synchronization signals for the base station to design the beam for use in multicast beamforming. Design of multicast beamforming has unique design challenges because the common beam is transmitted to the multiple UEs. The base station may balance different capabilities of the UEs and different downlink channel characteristics to the UEs to design the beam. It is desired to enhance the design of beamforming to more efficiently and effectively support UEs operating in the multicast configuration.

### SUMMARY OF THE DESCRIPTION

Methods and systems are disclosed for a UE to support a base station of a wireless network transmitting in a multicast beamforming configuration. In a network providing multicast service, the network may maintain a control policy for admission by granting a UE access to the multicast service based on the channel characteristics measured by the UE. For example, a base station of the 4G/5G network may transmit channel state information reference signals (CSI-RS) over physical resources reserved for multicast service. The base station may transmit the CSI-RS using one or more multicast beams. A UE wishing to join the multicast service may measure channel characteristics of the downlink channel based on the received multicast CSI-RS and may report the measurements back to the base station. The base station may admit or reject the UE for multicast service based on the reported measurements. The base station may also transmit synchronization signal block (SSB) signals over synchronization signal/physical broadcast channels (SS/PBCH) for channel measurements by the UE during cell search procedures and also during beam management procedures. The UE may measure channel state information of the downlink channel based on the SSB signals and may report the best downlink beam(s) during beam management procedures. The reporting of the channel state information allows rapid and responsive switching between beams. The measurements are affected by downlink beamforming designs including the downlink transmit beam from the base station and the UE's downlink receive beam. Disclosed are techniques for the UE and the base station to enhance the management and adaptation of the beams used to provide multicast PTM or concurrent multicast and unicast service. The disclosed techniques may also be applicable to 5G beamforming multicast and broadcast service (MBS) or 5G beamforming side-link group-cast service.

In one aspect, the technique may include measuring and reporting channel characteristics to support concurrent multicast and unicast transmissions from the same base station or different base stations. The UE may receive multicast and unicast transmissions concurrently in time carried on different beams or on the same beam. The base station may configure multiple multicast downlink transmission beams to balance the performance of a number of the multicast UEs. The UE may use one single downlink receive beam to receive both multicast and unicast transmissions. The UE may select one downlink receive beam that balances the performance of the multicast and unicast transmissions and may report one best downlink transmission beam for the base station to provide the multicast service. In one aspect, the UE may report multiple candidate downlink transmission beams for the multicast service rather than just one best downlink transmission beam. Each candidate downlink transmission beam may be aligned with a corresponding choice of UE side downlink receive beam.

Multicast transmission (for multicast UEs) may cause interference over unicast UEs using the same time and frequency resource occupied by the multicast transmission. In one aspect, the base station may select the multicast downlink transmission beam to mitigate the interference on unicast UEs so that the unicast UEs may leverage the same resources. The base station may rely on interference measurements and reporting from the unicast UEs by configuring CSI-RS resources for channel measurement of target signal by a unicast UE and CSI-RS resources for interference measurement by the unicast UE transmitted over one or more multicast beams. The unicast may measure and report the SINR from each of the one or more multicast transmission beams. The base station may select the multicast transmission beam by jointly considering both the multicast performance to the multicast UEs and the level of interference of the multicast transmission beam over other unicast UEs.

In one aspect, the base station may support PTM multicast service at the physical layer by transmitting a common multicast beam to the multicast UEs and may alternatively provide PTP multicast service by transmitting different beams to the UEs at the physical layer. The base station may support dynamic switching between the PTM and PTP configurations. When a UE detects beam failure for the multicast beam, as part of the beam failure recovery process, the UE may detect whether to switch from receiving the PTM transmission to the PTP transmission. The UE may report its preference about switching to the PTP transmission to the base station. In one aspect, the base station may configure different parameters such as block error rate for the UE to detect beam failures between multicast and unicast transmission.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one aspect of the disclosure.

FIG. 2 illustrates user equipment in direct communication with a base station (BS) according to one aspect of the disclosure.

FIG. 3 illustrates an example block diagram of a UE according to one aspect of the disclosure.

FIG. 4 illustrates an example block diagram of a BS according to one aspect of the disclosure.

FIG. 5 illustrates an example block diagram of cellular communication circuitry according to one aspect of the disclosure.

FIG. 6 illustrates a scenario for a base station of a wireless communication network to control admission of a UE to receive multicast service based on the UE measuring and reporting to the base station channel characteristics of downlink channels, according to one aspect of the disclosure.

FIG. 7 illustrates a flow diagram of signaling between the base station and the UE for the UE to gain admission to multicast resources based on the UE reporting measured channel quality of channel state information reference signals (CSI-RS) transmitted by the base station, according to one aspect of the disclosure.

FIG. 8 illustrates a scenario for the UE to receive concurrently in time multicast and unicast transmissions from the base station on different beams for the UE to report to the base station a downlink transmit beam for multicast transmission based on the performance of the multicast and unicast service, according to one aspect of the disclosure.

FIG. 9 illustrates a scenario in which the multicast transmission to multicast UEs causes interference over a unicast UE using the same time and frequency resources occupied by the multicast transmission and the unicast UE is configured to measure and report interference measurements for the base station to determine the multicast transmission beam to mitigate the multicast interference, according to one aspect of the disclosure.

FIG. 10 illustrates RRC signal resource configuration for beam failure detection that may include a field to distinguish between beam failure detection in multicast and unicast to facilitate beam failure recovery, according to one aspect of the disclosure.

FIG. 11 depicts a flow diagram of a method for a UE to measure channel characteristics of multiple candidate multicast beams to report a preferred multicast beam to a base station to enable the base station to configure a multicast beam to provide multicast service based on the preferred multicast beams reported by the UE and other UEs of a multicast group, according to one aspect of the disclosure.

### DETAILED DESCRIPTION

Methods and systems are disclosed for enhancements to multicast beamforming to support PTM multicast service, concurrent multicast and unicast service, MBS, or group side-link service at the physical layer. A base station or multicast UEs of a wireless communication network may apply the disclosed techniques to enhance the management and adaptation of downlink multicast beams used to provide service in PTM multicast, concurrent multicast and unicast, MBS, or group side-link configurations. The enhancements improve multicast service performance, flexibly accommodate the provisioning of simultaneous multicast and unicast services, and enhance multicast beam failure detection and recovery process. Multicast beamforming may also be applied to MIMO beamforming to increase diversity gain, array gain, or spatial multiplexing gain. Aspects of the enhancements are explained in the context of 4G LTE and 5G NR networks, but may be applied to other networks such as Wi-Fi, etc.

Enhancements to multicast beamforming may include techniques such as joint consideration of multicast and unicast performance of UEs receiving concurrent multicast and unicast physical downlink traffic when selecting multicast beamforming, multicast beamforming to reduce interference of the multicast transmission on unicast UEs receiving unicast service, and support for PTM or PTP multicast transmission at the physical layer to accommodate UE preferences for PTM/PTP in multicast beam failure detection and recovery process.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

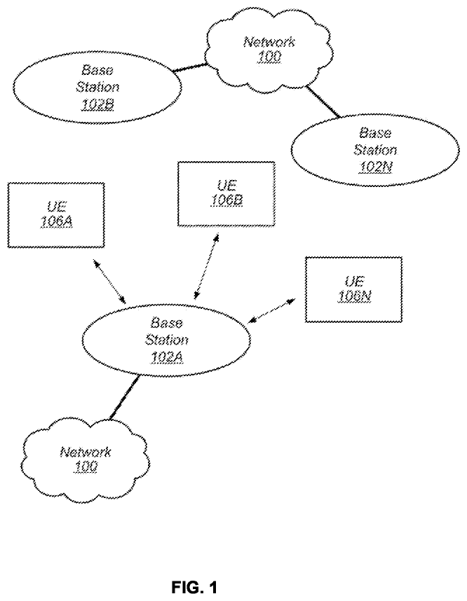

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

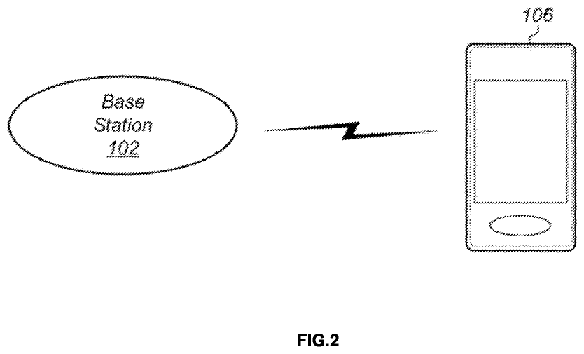

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

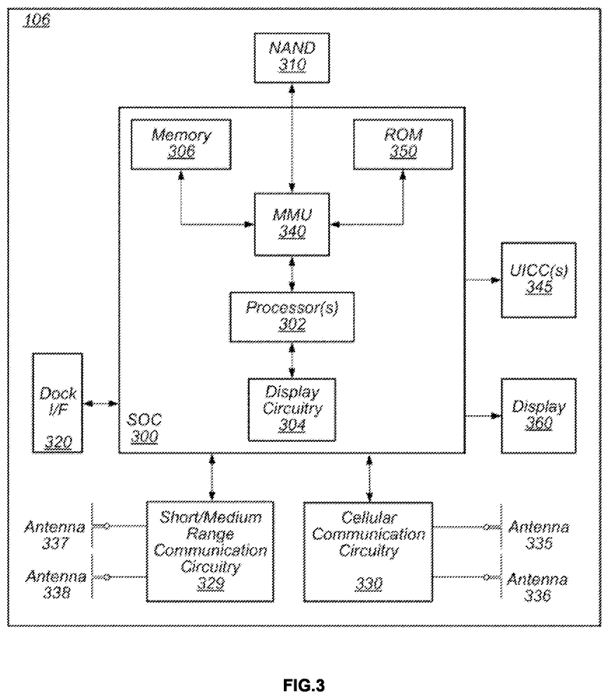

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

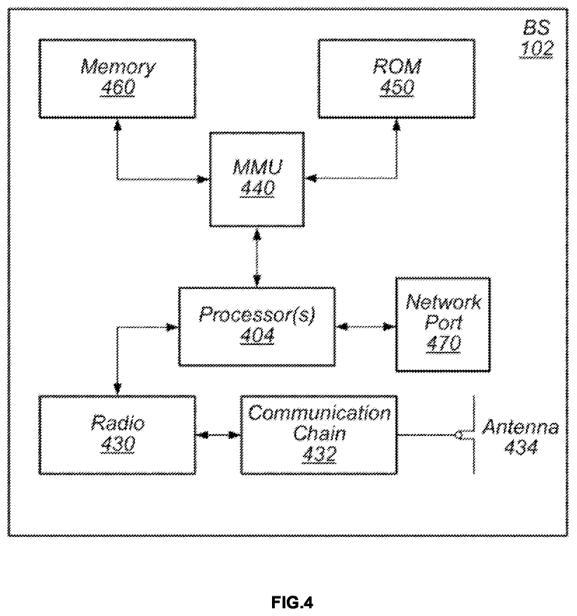

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

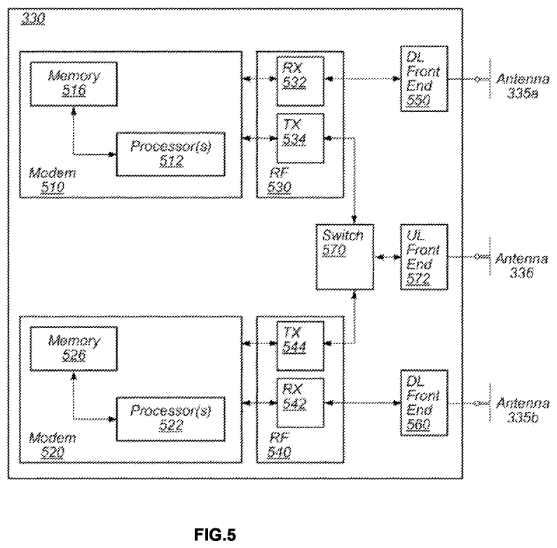

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

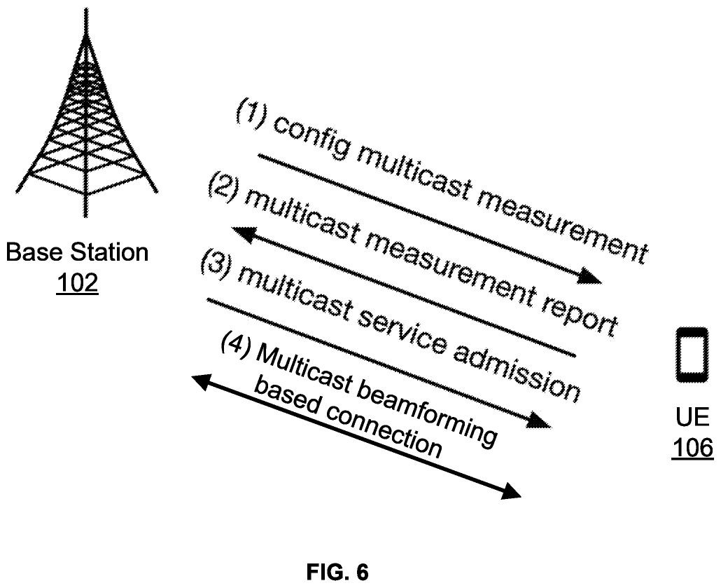

FIG. 6 illustrates a scenario for a base station 102 of a wireless communication network to control admission of a UE 106 to receive multicast service based on the UE measuring and reporting to the base station channel characteristics of downlink channels reserved for multicast service, according to one aspect of the disclosure. In the following description, the terms “base station” and “network” may be used interchangeably.

The base station 102 maintains a control policy for admission, where UEs are granted multicast service based on their measured channel quality. For example, the base station 102 may transmit channel state information reference signals (CSI-RS) over physical resource reserved for multicast service, where such CSI-RS may also be referred to as multicast CSI-RS. In one aspect, if the multicast transmission uses only 1-layer transmission, the multicast CSI-RS may be simply transmitted using 1-port. In one aspect, the base station 102 may transmit the multicast CSI-RS using one or more multicast beams. The base station 102 may transmit information to inform UEs of the physical resources used to transmit the CSI-RS and the configuration for reporting the measured channel characteristics.

A UE 106 wishing to join the multicast service may measure channel characteristics of the downlink channel based on the received multicast CSI-RS and may report the measurements back to the base station. In one aspect, the UE 106 may estimate channel characteristics using metrics such as channel quality indicator (CQI) and/or precoding matrix indicator (PMI) from the multicast CSI-RS. The CQI may represent the signal to interference plus noise ratio (SINR) calculated as a ratio of the target signal measured using the CSI-RS carried by the multicast beam and interference level measured when there is no transmission on the physical resources reserved for the multicast service. The PMI may allow the UE 106 to recommend a precoding matrix for the downlink multicast transmission in a closed loop beamforming scheme. The UE 106 may report the estimated CQI/PMI back to the base station 102. The CQI/PMI measurements are affected by downlink beamforming designs including the downlink multicast transmit beam from the base station 102 and the UE's (106) downlink receive beam. Using the CQI/PMI report, the network or the base station 102 may admit or reject the UE 106 for multicast service. The base station 102 may determine the multicast beam based on the measurement reports from the UEs admitted into the multicast group. The admitted UE 106 may then receive multicast service based on the connection established by the multicast beam.

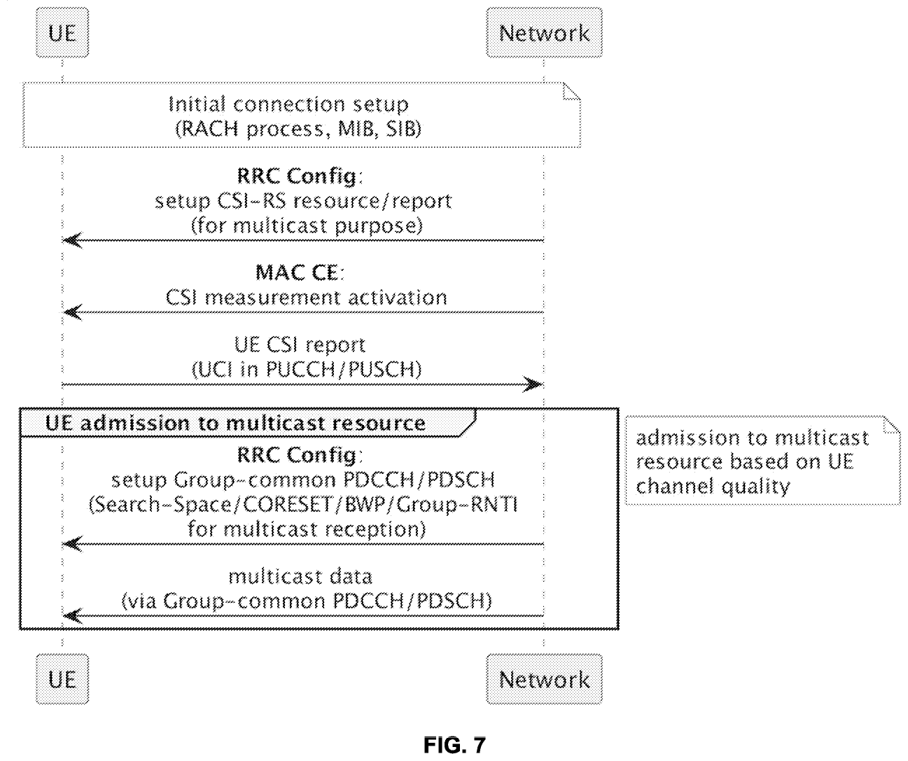

FIG. 7 illustrates a flow diagram of signaling between the base station of a 4G or 5G wireless network and a UE for the UE to gain admission to multicast resources based on the UE reporting measured channel quality of CSI-RS transmitted by the base station, according to one aspect of the disclosure.

The network may configure the UE for initial connection setup including resource configuration for the random access channel (RACH) process and system information such as master information block (MIB) and system information block (SIB) for the UE to access the network. When the UE accesses the network, the network may transmit radio resource control (RRC) messages to the UE to setup CSI-RS physical resources used by the base station to transmit the multicast CSI-RS and the reporting configuration used by the UE to report the measured channel quality based on the multicast CSI-RS. The network may transmit medium access control (MAC) control element (CE) on the physical downlink shared channel (PDSCH) to activate the CSI-RS measurement by the UE.

The UE wishing to receive multicast service may measure channel characteristics such as CQI/PMI of the multicast CSI-RS and may report the measurement as uplink control information (UCI) as part of the channel state information (CSI) reporting carried on the physical uplink control channel (PUCCH) or the physical uplink shared channel (PUSCH). The measurements are affected by multicast downlink (DL) beamforming design including the base station's multicast DL transmit beam and the UE's DL receive beamforming. The network may perform multicast beamforming and beam management based on the measurements reported by UEs already admitted into the multicast group and UEs wishing to join the multicast group.

The network may grant admission to the UE to receive multicast resources based on the measured channel characteristics reported by the UE. In one aspect, the network may transmit to the UE RRC configuration message containing multicast group-common signaling to the admitted UE to setup the physical downlink control channel (PDCCH) or the PDSCH for the UE to receive multicast service. In one aspect, the multicast group-common signaling may include search-space, control resource set (CORESET), bandwidth part (BWP), and group-common radio network temporary identifier (RNTI) for multicast reception. The UE may then receive multicast data via the multicast group-common PDCCH or PDSCH.

In one aspect, the UE may measure and report channel characteristics to support concurrent multicast and unicast transmissions from the same base station or from different base stations, such as in a multi-transmission/reception point (multi-TRP) scenario. The UE may receive multicast and unicast PDSCH concurrently in time carried on different beams or on the same beam. The UE may use the same hardware resource to receive the multicast and unicast PDSCH, which may be transmitted using frequency range 2 (FR2 of 24.25 GHz to 52.60 GHz). The base station may configure the multicast downlink transmission beam to balance the performance of a number of the multicast UEs, while the base station may steer the unicast downlink transmission beam to a specific UE.

The UE may use one single downlink receive beam to receive both multicast and unicast transmissions. For example, in FR2, the UE may use only one single Rx analog beam to receive both multicast and unicast payload due to hardware limitation. To improve support for concurrent multicast and unicast service using one Rx beam, the UE may enhance Rx beam adaption and Rx beam measurement reporting, and the network may define the priority of multicast beam versus unicast beam for PDSCH reception. For example, the UE may select one downlink receive beam that balances the performance of the multicast and unicast transmissions and may report one best downlink transmission beam for the base station to provide the multicast service. In one aspect, the UE may report multiple candidate downlink transmission beams for the multicast service rather than just one best downlink transmission beam. Each candidate downlink transmission beam may be aligned with a corresponding choice of UE side downlink receive beam.

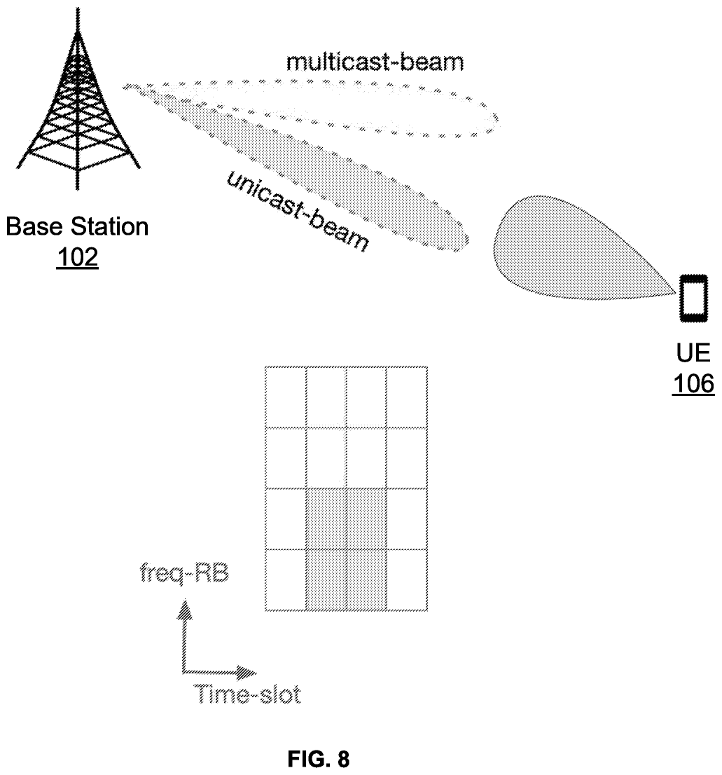

FIG. 8 illustrates a scenario for the UE to receive concurrently in time multicast and unicast transmissions from the base station on different beams for the UE to report to the base station a downlink transmit beam for multicast transmission based on the performance of the multicast and unicast service, according to one aspect of the disclosure. The multicast beam and the unicast beam may be transmitted in the same time slots using different frequency resource blocks.

In one aspect to enhance UE Rx beam adaption, the UE may report one best DL Tx beam for multicast, and this (DL Tx) beam's quality is based on the selection of one UE side Rx analog beam. In this sense, UE may select a Rx analog beam that balances the performance of multicast and unicast. For example, the UE may maximize unicast performance with a minimum requirement for multicast performance; the UE may maximize multicast performance with a minimum requirement for unicast performance; or the UE may perform a hybrid trade-off between unicast and multicast performance. In one aspect of the hybrid optimization scheme, the network may assign one weight for multicast and the other weight for unicast, where the optimization target is weighted sum quality from both multicast and unicast.

In one aspect, the network may define the priority of multicast beam vs unicast beam for PDSCH reception. As an example, the network may define that multicast beam priority is always higher than unicast beam priority (or vice versa). The network may also define above priority using RRC configuration message in a semi-static way; network may further dynamically adjust this priority via PDCCH-DCI. For RRC configuration, this information may be either part of “CSI-ReportConfig”, or part of group-common PDSCH-configuration. For PDCCH-DCI dynamic configuration, this information may be carried over via DCI 1-0 with CRC scrambled by Group-RNTI.

In one aspect to enhance Rx beam measurement reporting, UE may report a few (multiple) candidates for multicast DL Tx beams rather than just one single DL Tx beam. For example, each DL Tx beam candidate may be aligned with one choice of UE side Rx analog beam. All these DL Tx beam candidates can meet certain performance threshold. Such multi-beam candidates may provide the network with a better optimization space. The reporting of the DL Tx beam candidates may use CSI-report through UCI info bits within PUCCH or PUSCH.

Multicast transmission (for multicast UEs) may cause interference over unicast UEs using the same time and frequency resource occupied by the multicast transmission. In one aspect, the base station may select the multicast downlink transmission beam to mitigate the interference on unicast UEs so that the unicast UEs may leverage the same resources to improve resource utilization efficiency. The base station may rely on interference measurements and reporting from the unicast UEs by configuring CSI-RS resources for channel measurement of target signal by a unicast UE and CSI-RS and channel state information interference measurement (CSI-IM) resources for interference measurement of one or more multicast beams by the unicast UE. The network may broadcast one or multiple multicast DL Tx beams over such CSI-RS/CSI-IM resources. The unicast UE may measure and report the SINR from each of the one or more multicast Tx beams. The base station may select the multicast Tx beam by jointly considering both the multicast performance to the multicast UEs and the level of interference of the multicast transmission beam over other unicast UEs.

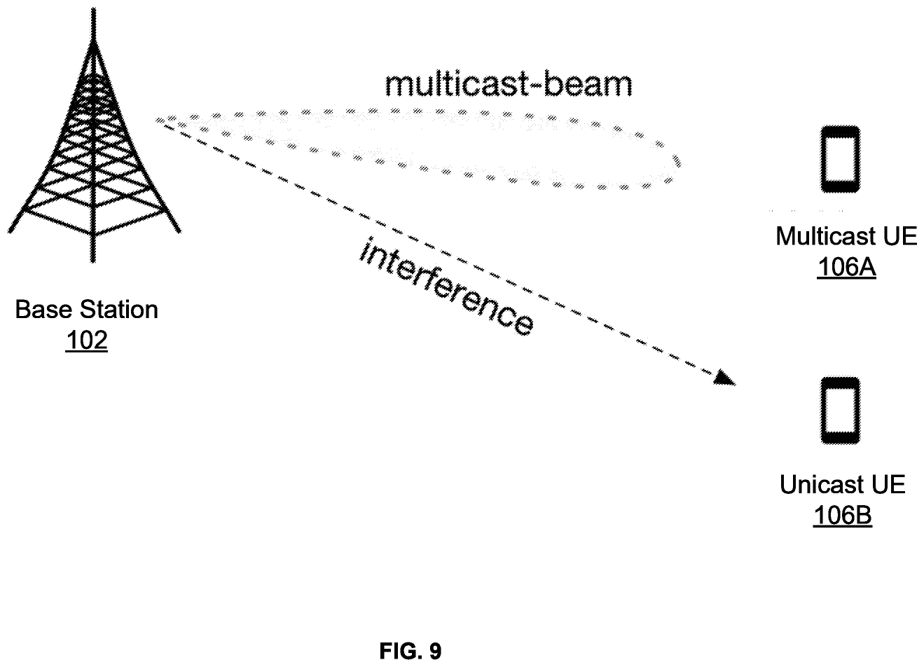

FIG. 9 illustrates a scenario in which the multicast transmission to multicast UE 160A causes interference over a unicast UE 106B using the same time and frequency resources occupied by the multicast transmission and the unicast UE 106B is configured to measure and report interference measurements for the base station to determine the multicast transmission beam to mitigate the multicast interference, according to one aspect of the disclosure.

In one aspect, the unicast UE 106B may report L1-SINR metric to indicate the interference from each multicast beam. L1-SINR is layer-1 signal-to-interference plus noise ratio. It may be estimated from target signal strength, and interference level. These two metrics can be estimated from different reference signals. For example, unicast UE 106B may estimate the target signal strength using CSI-RS resources of the unicast Tx beam and may estimate the interference using CSI-RS/CSI-IM resources of one or more multicast Tx beams. Unicast UE 106B's L1-SINR estimation may be based on multicast interference suppression or cancellation technique. In one aspect of the suppression technique, the unicast UE 106B may use its Rx beam to suppress multicast interference. In one aspect of the cancellation technique, the unicast 106B may first cancel the multicast interference and then decode the target signal. In one aspect, the unicast 106B may report L1-SINR as part of CSI-report, which is reported to network via UCI bits in PUCCH or PUSCH. The network may select multicast DL Tx beam by jointly considering both the multicast performance to UEs in the multicast group including UE 106A and its interference over unicast UE 106B.

A UE may monitor the radio link of multiple multicast beams to switch between the beams. A base station may use RRC signaling such as “RadioLinkMonitoringConfig” to configure the UE with radio link monitoring reference signal (RLM-RS) resources such as SSB or CSI-RS. The UE may monitor the RLM-RS resources to switch between beams as the radio conditions change over time. The UE may provide the base station with information regarding the preferred beam when reporting channel state information. The UE may also monitor the RLM-RS resources to detect beam failures. The UE may experience beam failures if the radio condition changes such that existing beam becomes unreliable before the UE is able to switch to a new beam. When a beam failure is detected, the UE may attempt to recover by initiating a beam failure recovery (BFR) procedure.

The UE may detect a beam failure based on estimates of hypothetical PDCCH BLER using beam failure detection (BFD) resources such as the RLM-RS resources. For example, the base station may configure the UE with a Qout_LR to correspond to a quality at which the BLER belonging to a hypothetical PDCCH transmission is 10%, indicating that the PDCCH reception is not reliable. The hypothetical PDCCH may have a control channel element (CCE) aggregation level of 8 and CORESET spanning 2 OFDM symbols. The UE may declare a beam failure when the radio link quality belonging to all of the monitored RLM-RS resources fall below Qout_LR at a certain configured rate. The UE may then identify a new target beam and initiate a RACH procedure using a random access preamble allocated to the new target beam as part of the BFR procedure.

In multicast transmission, multiple UEs are receiving the multicast beam from the base station. Multicast beam quality is determined by multiple links between the base station and the multiple UEs of the multicast group. If the base station declares a beam failure based on a single link between the base station and one of the multicast UEs, the multicast service may become unreliable since blockage of a single multicast UE may result in interruption of multicast communication to the rest of multicast UEs. It is desired to enhance the BFR process for multicast beamforming.

In one aspect, the base station may support PTM multicast service at the physical layer by transmitting a common multicast beam to the multicast UEs and may alternatively provide PTP multicast service by transmitting different beams to the UEs at the physical layer. The base station may support dynamic switching between the PTM and PTP configurations. When a UE detects beam failure for the multicast beam, as part of the beam failure recovery process, the UE may detect whether to switch from receiving the PTM transmission to the PTP transmission. The UE may report its preference about switching to the PTP transmission to the base station. In one aspect, the base station may configure different parameters such as block error rate for the UE to detect beam failures between multicast and unicast transmission.

In one aspect, when the UE receives PTM service on a multicast beam, the UE may detect beam failure of the multicast beam. As part of the BFR process, the UE may generate BFR MAC CE and include it in MAC PDU of MSG3 as part of the RACH procedure. When the UE measures and reports an alternative multicast beam, the UE may detect whether it may switch from receiving PTM transmission to PTP transmission. The BFR MAC CE may be modified to include a bit field “PTP.” For example, if this bit field is 1, it indicates that the UE prefers switching to receiving PTP transmission for multicast payload reception. As such, the UE may indicate its preference about switching to receiving PTP transmission in its beam failure report (e.g., BFR MAC CE) as part of the BFR process.

In one aspect, the network may distinguish the BFR configuration between multicast and unicast transmissions. For example, the network may define different BLER targets and/or different BLER detection assumptions (e.g., control channel elements (CCE) aggregation level of the hypothetical PDCCH) for multicast and unicast transmissions. In one aspect, the network may use a new field in RRC signaling “RadioLinkMonitoringConfig” to configure BFD resources for multicast transmission.

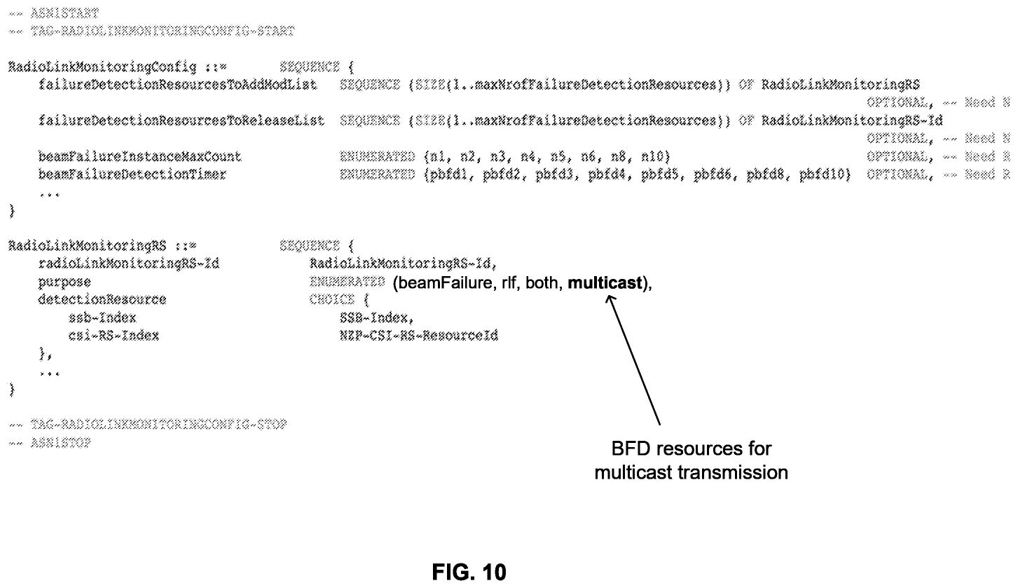

FIG. 10 illustrates RRC signal resource configuration “RadioLinkMonitoringConfig” for beam failure detection that may include a field to distinguish between beam failure detection in multicast and unicast transmissions to facilitate beam failure recovery, according to one aspect of the disclosure.

In one aspect, a new field in “RadioLinkMonitoringRS->purpose” may be defined to include a new enumerated value ‘multicast’:
purpose ENUMERATED {beamFailure, rlf, both, multicast}
   The “RadioLinkMonitoringRS->purpose” parameter is linked to a RLM-RS resource such as SSB or CSI-RS and instructs the UE to use the linked RLM-RS resource for beam failure detection, radio link monitoring, or both. By defining this new field, the network may distinguish beam failure detection resources for multicast transmission from those for unicast transmission.

As mentioned, beam failure detection may be based on a given BLER threshold under a hypothetical PDCCH setting. For example, the threshold Qout_LR may be defined as the level at which the downlink radio level link of a given resource configuration on set q0 cannot be reliably received and may correspond to the BLERout=10% block error rate of a hypothetical PDCCH transmission (e.g., a control channel element (CCE) aggregation level of 8 and CORESET spanning 2 OFDM symbols). For SSB based beam failure detection, Qout_LR_SSB may be derived based on a first set of hypothetical PDCCH transmission parameters. For CSI-RS based beam failure detection, Qout_LR_CSI-RS may be derived based on a second set of hypothetical PDCCH transmission parameters.

In one aspect, when the resource configuration is defined for multicast beam failure detection, BLER thresholds and PDCCH parameters may be specially defined. For example, BLER target for multicast BFD may be higher or lower than 10%, while the set of hypothetical PDCCH transmission parameters may be based on different values of “Number of control OFDM symbols”, “Aggregation level (CCE)”, “Bandwidth (PRBs),” etc.

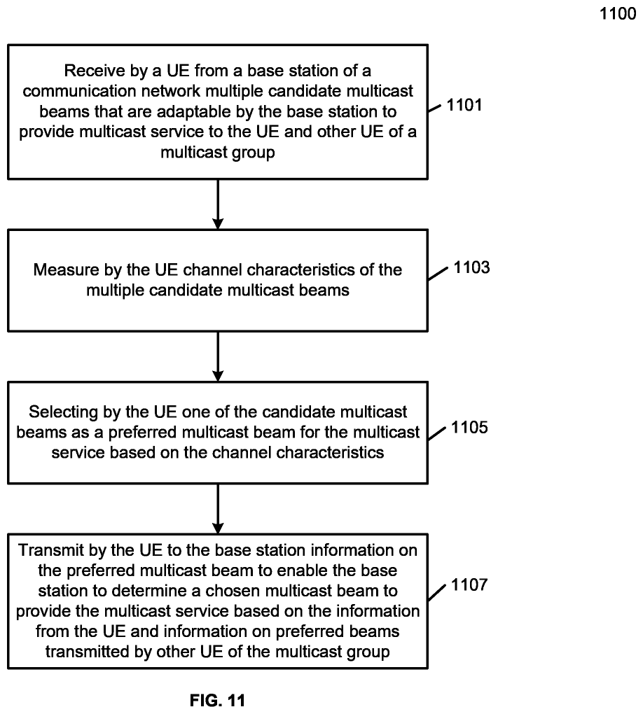

FIG. 11 depicts a flow diagram of a method for a UE to measure channel characteristics of multiple candidate multicast beams to report a preferred multicast beam to a base station to enable the base station to configure a multicast beam to provide multicast service based on the preferred multicast beams reported by the UE and other UEs of a multicast group, according to one aspect of the disclosure. The method may be practiced by the UE of FIGS. 1, 2, 3, 5, 6, 7, 9, and 10.

In operation 1101, the UE receives from a base station of a communication network multiple candidate multicast beams that are adaptable by the base station to provide multicast service to the UE and other UE of a multicast group.

In operation 1103, the UE measures channel characteristics of the multiple candidate multicast beams.

In operation 1105, the UE selects one of the candidate multicast beams as a preferred multicast beam for the multicast service based on the channel characteristics.

In operation 1107, the UE transmits to the base station information on the preferred multicast beam to enable the base station to determine a chosen multicast beam to provide the multicast service based on the information from the UE and information on preferred beams transmitted by other UE of the multicast group.

In one aspect, the described operations to enhance the management and adaptation of downlink multicast beams to improve multicast service performance, accommodate the provisioning of simultaneous multicast and unicast services, and enhance multicast beam failure detection and recovery process may be practiced by a UE that includes at least one antenna, at least one radio, and at least one processor. The radio may be configured to communicate with a communication network (e.g., a base station) through the antenna to receive multiple candidate multicast beams that are adaptable by the communication network to provide multicast service to the UE and other UEs of a multicast group.

The processor may be coupled to the radio and configured to perform the described operations. The operations may include the UE measuring channel characteristics of the multiple candidate multicast beams. The operations may also include the UE selecting one of the candidate multicast beams as a preferred multicast beam for the multicast service based on the channel characteristics. The operations may further include the UE reporting information on the preferred multicast beam to the communication network to enable the communication network to determine a chosen multicast beam to provide the multicast service based on the information from the UE and information on preferred multicast beams transmitted by other UEs of the multicast group.

In one aspect, the radio of the UE may receive from the communication network a unicast beam concurrently in time with at least one candidate multicast beam. The unicast beam may be used to provide unicast service. The UE may select a receive beam to receive concurrently the unicast beam and the at least one candidate multicast beam.

In one aspect, the UE may select multiple preferred multicast beams for the multicast service based on the channel characteristics. A separate receive beam of the UE may be selected to receive concurrently the unicast beam and a respective one of the multiple preferred multicast beams.

In one aspect, the radio of the UE may receive from the communication network a unicast beam that provides unicast service concurrently in time with the chosen multicast beam. The unicast beam and the chosen multicast beam occupy common channel resources. The UE may measure channel characteristics of the unicast beam. The channel characteristics of the unicast beam may be affected by interference from the chosen multicast beam. The UE may report the channel characteristics of the unicast beam to the communication network to enable the communication network to change the chosen multicast beam to mitigate the interference on the unicast beam from the chosen multicast beam.

In one aspect, to measure the channel characteristics of the unicast beam, the UE may measure strength of a target signal based on reference signal resources transmitted on the unicast beam. The UE may measure a multicast interference level based on reference signal resources transmitted on the chosen multicast beam. The reference signal resources of the unicast beam and the reference signal resources of the chosen multicast beam may occupy common channel resources. The UE may determine a signal-to-noise-interference-ratio (SINR) between the strength of the target and the multicast interference level.

In one aspect, UE may receive the chosen multicast beam from the communication network through the radio to receive the multicast service in a point-to-multipoint (PTM) configuration. The UE may measure channel characteristics of the chosen multicast beam to detect a beam failure. The UE may select one of the candidate multicast beams as a newly preferred multicast beam for the multicast service based on the channel characteristics in response to the beam failure. The UE may report to the communication network information on the newly preferred multicast beam and an indication of a preference to receive the multicast service in a point-to-point (PTP) configuration using the newly preferred multicast beam.

In one aspect, the UE may receive from the communication network configuration information used for detecting beam failure of a multicast beam. The configuration information used for detecting beam failure of a multicast beam may be distinguishable from configuration information used for detecting beam failure of a unicast beam. The UE may detect a beam failure of the chosen multicast beam based on the configuration information. The UE may select one of the candidate multicast beams as a newly preferred multicast beam for the multicast service based on the channel characteristics in response to the beam failure. The UE may report information on the newly preferred multicast beam to the communication network.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to communicate with a communication network (e.g., a base station) to receive multiple candidate multicast beams that are adaptable by the communication network to provide multicast service to the UE and other UEs of a multicast group, measure channel characteristics of the multiple candidate multicast beams, select one of the candidate multicast beams as a preferred multicast beam for the multicast service based on the channel characteristics, and report information on the preferred multicast beam to the communication network to enable the communication network to determine a chosen multicast beam to provide the multicast service based on the information from the UE and information on preferred multicast beams transmitted by other UEs of the multicast group.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A baseband processor of a wireless user equipment (UE) of a communication network configured to provide multicast service, comprising:
receiving from a base station of the communication network a plurality of candidate multicast beams that are adaptable by the base station to provide multicast service to the UE and at least one other UE of a multicast group;
measuring channel characteristics of the plurality of candidate multicast beams;
selecting one of the candidate multicast beams as a preferred multicast beam for the multicast service based on the channel characteristics; and
transmitting to the base station information on the preferred multicast beam to enable the base station to determine a chosen multicast beam to provide the multicast service based on the information from the UE and information on preferred multicast beam transmitted by the at least one other UE of the multicast group.

2. The baseband processor of claim 1, further comprising:
receiving from the base station or a second base station a unicast beam concurrently in time with at least one of the candidate multicast beams, wherein the unicast beam is used to provide unicast service; and
selecting a receive beam to receive concurrently the unicast beam and the at least one candidate multicast beams.

3. The baseband processor of claim 2, wherein selecting the receive beam comprises:
configuring the receive beam to prioritize the unicast service over the multicast service when receiving concurrently the unicast service and the multicast service.

4. The baseband processor of claim 2, wherein selecting the receive beam comprises:
configuring the receive beam to prioritize the multicast service over the unicast service when receiving concurrently the multicast service and the unicast service.

5. The baseband processor of claim 2, wherein selecting the receive beam comprises:
receiving a weight for the multicast service and a weight for the unicast service; and
configuring the receive beam based on a weighted sum of the multicast service and the unicast service using the weight for the multicast service and the weight for the unicast service when receiving concurrently the multicast service and the unicast service.

6. The baseband processor of claim 2, wherein the weight for the multicast service and the weight for the unicast service are received from the base station to configure relative priorities of the multicast service and the unicast service.

7. The baseband processor of claim 2, wherein selecting one of the candidate multicast beams as a preferred multicast beam comprises:
selecting a plurality of preferred multicast beams for the multicast service based on the channel characteristics, wherein a separate receive beam is selected to receive concurrently the unicast beam and each of the plurality of preferred multicast beams.

8. The baseband processor of claim 7, wherein transmitting to the base station information on the preferred multicast beam comprises:
transmitting information on the plurality of preferred multicast beams to enable the base station to determine the chosen multicast beam to provide the multicast service; and
receiving the chosen multicast beam concurrently with the unicast beam using a receive beam to receive concurrently in time the multicast service and the unicast service.

9. The baseband processor of claim 1, further comprising:
receiving from the base station a unicast beam providing unicast service concurrently in time with the chosen multicast beam, wherein the unicast beam and the chosen multicast beam occupy common channel resources;
measuring channel characteristics of the unicast beam, wherein the channel characteristics of the unicast beam are affected by interference from the chosen multicast beam; and
reporting to the base station the channel characteristics of the unicast beam to enable the base station to change the chosen multicast beam to mitigate the interference on the unicast beam from the chosen multicast beam.

10. The baseband processor of claim 9, wherein measuring channel characteristics of the unicast beam comprises:
measuring strength of a target signal based on reference signal resources transmitted on the unicast beam;
measuring a multicast interference level based on reference signal resources transmitted on the chosen multicast beam, wherein the reference signal resources of the unicast beam and the reference signal resources of the chosen multicast beam occupy common channel resources; and
determining a ratio between the strength of the target and the multicast interference level.

11. The baseband processor of claim 10, wherein measuring the multicast interference level comprises:
configuring a receive beam to receive the unicast beam to suppress the multicast interference level.

12. (canceled)

13. (canceled)

14. The baseband processor of claim 13, wherein the information on the newly preferred multicast beam is transmitted during a random access procedure used by the UE to re-connect with the base station.

15. (canceled)

16. The baseband processor of claim 1, further comprising:
receiving from the base station configuration information for detecting beam failure of a multicast beam;
detecting a beam failure of the chosen multicast beam based on the configuration information;
selecting one of the candidate multicast beams as a newly preferred multicast beam for the multicast service based on the channel characteristics in response to the beam failure; and
transmitting to the base station information on the newly preferred multicast beam.

17. The baseband processor of claim 16, wherein the configuration information for detecting beam failure of a multicast beam is distinguishable from configuration information for detecting beam failure of a unicast beam.

18. The baseband processor of claim 17, wherein the configuration information comprises:
a block error rate (BLER) threshold of a hypothetical packet, wherein the BLER threshold corresponds to a quality threshold of the multicast beam; and
parameters associated with the packet.

19. A base station of a communication network, comprising:
at least one antenna;
at least one radio, wherein the at least one radio is configured to communicate with a communication network using the at least one antenna; and
at least one processor coupled to the at least one radio, wherein the at least one processor is configured to perform operations comprising:
transmit a plurality of candidate multicast beams that are adaptable by the base station to provide multicast service to a plurality of wireless user equipment (UEs) of a multicast group;
receive from the multicast group a plurality of preferred multicast beams based on channel characteristics of the plurality of candidate multicast beams measured by the plurality of UEs;
determine a multicast beam to provide the multicast service based on the plurality of preferred multicast beams; and
transmit the multicast beam to provide the multicast service.

20. The base station of claim 19, wherein the at least one processor is further configured to:
transmit a unicast beam to provide unicast service to one of the UEs of the multicast group concurrently in time with at least one of the candidate multicast beams; and
transmit to the one UE of the multicast group receiving the unicast service information on relative priorities of the multicast service and the unicast service.

21. The base station of claim 19, wherein the at least one processor is further configured to:
transmit a unicast beam to provide unicast service to a unicast UE not in the multicast group concurrently in time with the multicast beam, wherein the multicast beam and the uncast beam occupy common channel resources;
receive from the unicast UE measured information on interference of the unicast beam by the multicast beam; and
determine a new multicast beam to provide the multicast service based on the measured information from the uncast UE.

22. The base station of claim 19, wherein the at least one processor is further configured to:
transmit the multicast beam in a point-to-multipoint (PTM) configuration to provide the multicast service;
receive from one of the UEs of the multicast group a target multicast beam selected from one of the plurality of candidate multicast beams in response to a beam failure detected by the one UE;
receive from the one UE a preference to for the multicast service in a point-to-point (PTP) configuration using the target multicast beam; and
transmit a new beam based on the target multicast beam to the one UE to provide the multicast service in the PTP configuration.

23. The base station of claim 19, wherein the at least one processor is further configured to:
transmit to the plurality of UEs of the multicast group configuration information for detecting beam failure of the multicast beam, wherein the configuration information for detecting beam failure of the multicast beam is distinguishable from configuration information for detecting beam failure of a unicast beam.
